(19) United States
(12) Patent Application Publication
(10) Pub. No.: US 2025/0267102 A1
(43) Pub. Date: Aug. 21, 2025

(54) SYSTEMS AND METHODS FOR SELECTION OF CELLULAR SLICE FOR APPLICATION TRAFFIC

(71) Applicant: Meta Platforms Technologies, LLC, Menlo Park, CA (US)

(72) Inventors: Shivank Nayak, Milpitas, CA (US); Youngrak Lee, San Diego, CA (US)

(73) Assignee: Meta Platforms Technologies, LLC, Menlo Park, CA (US)

(21) Appl. No.: 19/048,827

(22) Filed: Feb. 7, 2025

Related U.S. Application Data
(60) Provisional application No. 63/554,193, filed on Feb. 16, 2024.

(51) Int. Cl. H04L 47/24; H04L 45/302

(52) U.S. Cl. CPC H04L 47/24; H04L 45/308

(57) ABSTRACT

Systems and methods for selection of cellular slices for application traffic may include a user equipment which receives a message indicating a change in session capabilities, from a first session capability indicating one or more first services used in a first session to a second session capability indicating one or more second services to be used in a second session. The first session may correspond to a first bearer within a first quality of service (QOS) slice and associated with a first application identifier of an application. The user equipment may configure a second application identifier for the application based on the second session capability. The user equipment may transmit, via a transceiver to a base station, traffic of the application, using the second application identifier, via the second session.

### CROSS-REFERENCE TO RELATED APPLICATIONS

This application claims the benefit of and priority to U.S. Provisional Application No. 63/554,193, filed Feb. 16, 2024, the contents of which are incorporated herein by reference in its entirety.

### FIELD OF DISCLOSURE

The present disclosure is generally related to wireless communication, including but not limited to, systems and methods for forward error correction for cellular communications.

### BACKGROUND

Augmented reality (AR), virtual reality (VR), and mixed reality (MR) are becoming more prevalent, which such technology being supported across a wider variety of platforms and device. Some AR/VR/MR devices may communicate with one or more other remote devices via a cellular connection.

### SUMMARY

In one aspect, this disclosure relates to a method. The method may include receiving, by user equipment, a message indicating a change in session capabilities, from a first session capability indicating one or more first services used in a first session to a second session capability indicating one or more second services to be used in a second session. The first session may correspond to a first bearer within a first quality of service (QOS) slice and associated with a first application identifier of an application. The method may include configuring, by the user equipment, a second application identifier for the application based on the second session capability. The method may include transmitting, by the user equipment to a base station, traffic of the application, using the second application identifier, via the second session.

In some embodiments, the application includes a first application. The method may include identifying, by the user equipment, based on the second session capability, an active session used by a second application within a second QoS slice. The method may include configuring, by the user equipment, the second application identifier responsive to identifying the active session. In some embodiments, the active session includes a first QoS flow within the second QoS slice. The method may further include requesting, by the user equipment, a second QoS flow within the second QoS slice for the first application.

In some embodiments, the method further includes establishing, by the user equipment, the second session for the application with the base station, the second session corresponding to a second bearer for a second QoS slice. In some embodiments, the method further includes receiving, by the user equipment from the base station, a configuration of user equipment route selection policy (USRP) rules from the base station, the USRP rules indicating one or more criterion for selecting application identifiers based on session capabilities and corresponding QoS slices. In some embodiments, the user equipment configures the second application identifier based on the USRP rules.

In some embodiments, the message includes a second message. The method may further include receiving, by the user equipment, a first message indicating the first session capability. The method may further include transmitting, by the user equipment to the base station, a request to establish the first session for the application based on the first session capability, the request including the first application identifier for the application. The method may further include establishing, by the user equipment with the base station, the first session within the first QoS slice, for the application. In some embodiments, the base station includes a first base station, and the traffic is sent to a cell of the first base station. The method may include maintaining, by the user equipment, the second application identifier for the application during a handover to a second cell of the first base station or a second base station. The method may further include receiving, by the user equipment, updated user equipment route selection policy (USRP) rules from the second cell. The method may further include activating the second session within the second QoS slice based on the updated URSP rules. In some embodiments, the user equipment includes a first user equipment, and the first user equipment receives the traffic for transmission to the base station from a user equipment communicably coupled to the first user equipment.

In another aspect, this disclosure is directed to a user equipment including a transceiver, and one or more processors configured to receive a message indicating a change in session capabilities, from a first session capability indicating one or more first services used in a first session to a second session capability indicating one or more second services to be used in a second session. The first session may correspond to a first bearer within a first quality of service (QoS) slice and associated with a first application identifier of an application. The one or more processors may be configured to configure a second application identifier for the application based on the second session capability. The one or more processors may be configured to transmit, via the transceiver to a base station, traffic of the application, using the second application identifier, via the second session.

In some embodiments, the application includes a first application. The one or more processors may be configured to identify, based on the second session capability, an active session used by a second application within a second QoS slice. The one or more processors may be configured to configure the second application identifier responsive to identifying the active session. In some embodiments, the active session includes a first QoS flow within the second QoS slice. The one or more processors may be configured to transmit, via the transceiver to the base station, a request for a second QoS flow within the second QoS slice for the first application. In some embodiments, the one or more processors are configured to establish, via the transceiver, the second session for the application with the base station, the second session corresponding to a second bearer for a second QoS slice.

In some embodiments, the one or more processors are configured to: receive, via the transceiver from the base station, a configuration of user equipment route selection policy (USRP) rules from the base station, the USRP rules indicating one or more criterion for selecting application identifiers based on session capabilities and corresponding QoS slices. In some embodiments, the one or more processors configure the second application identifier based on the USRP rules.

In some embodiments, the message includes a second message. The one or more processors may be configured to receive a first message indicating the first session capability. The one or more processors may be configured to transmit, via the transceiver to the base station, a request to establish the first session for the application based on the first session capability, the request including the first application identifier for the application. The one or more processors may be configured to establish, via the transceiver with the base station, the first session within the first QoS slice, for the application. In some embodiments, the base station includes a first base station. The traffic may be sent to a cell of the first base station. The one or more processors may be configured to maintain the second application identifier for the application during a handover to a second cell of the first base station or a second base station. The one or more processors may be configured to receive updated user equipment route selection policy (USRP) rules from the second cell. The one or more processors may be configured to activate the second session within the second QoS slice based on the updated URSP rules. In some embodiments, the one or more processors are configured to receive, via the transceiver, the traffic for transmission to the base station from a second user equipment communicably coupled to the user equipment. In some embodiments, the traffic is received from the user equipment, responsive to the application at least partially executing on the second user equipment and generating the traffic.

In yet another aspect, this disclosure is directed to to a non-transitory computer readable medium storing instructions that, when executed by one or more processors, cause the one or more processors to receive a message indicating a change in session capabilities, from a first session capability indicating one or more first services used in a first session to a second session capability indicating one or more second services to be used in a second session. The first session may correspond to a first bearer within a first quality of service (QOS) slice and associated with a first application identifier of an application. The instructions may cause the one or more processors to configure a second application identifier for the application based on the second session capability. The instructions may cause the one or more processors to transmit, via a transceiver to a base station, traffic of the application, using the second application identifier, via the second session.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for selection of a slice for application traffic, according to an example implementation of the present disclosure.

FIG. 6 is a process flow showing dynamic slice selection based on application data session services, according to an example implementation of the present disclosure.

FIG. 7 is a flowchart showing an example method of dynamic slice selection based on application data session services, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

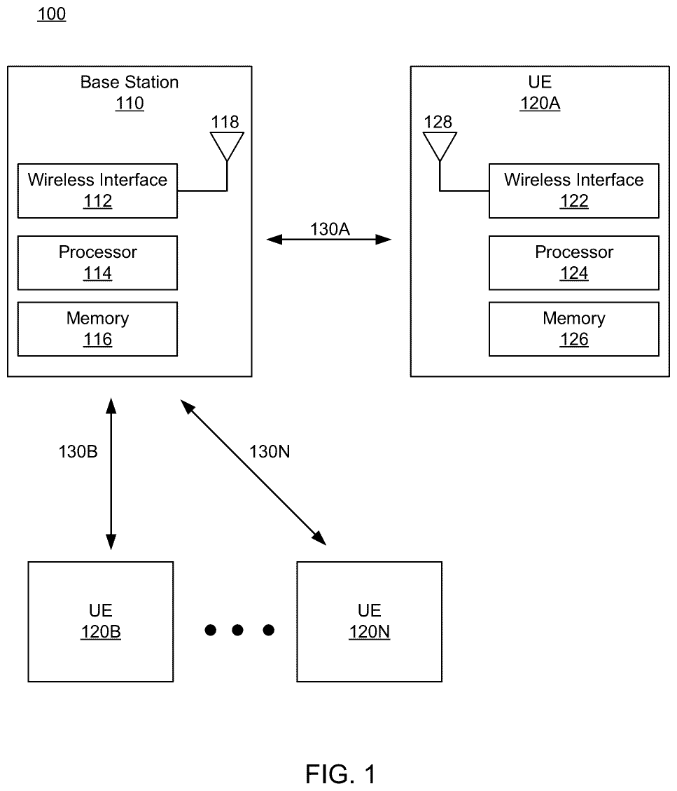

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHZ). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHZ). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

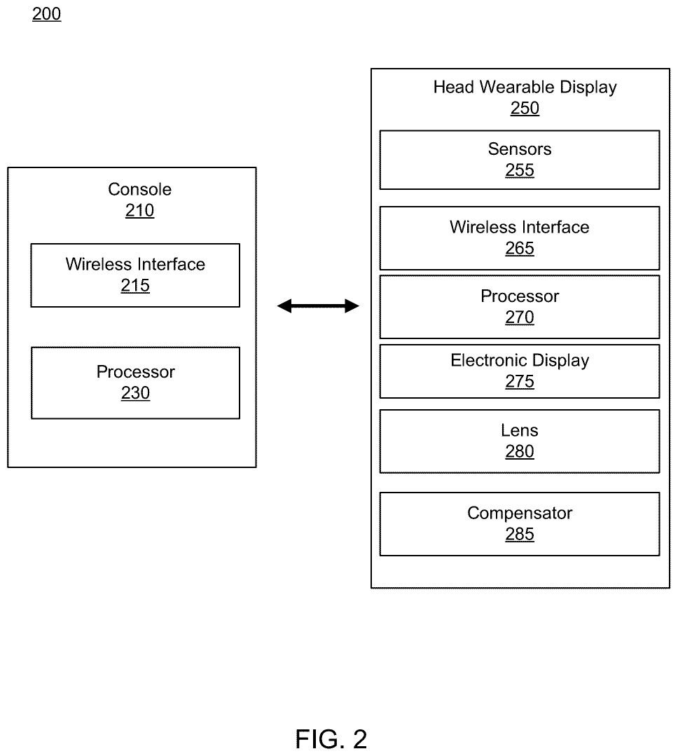

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

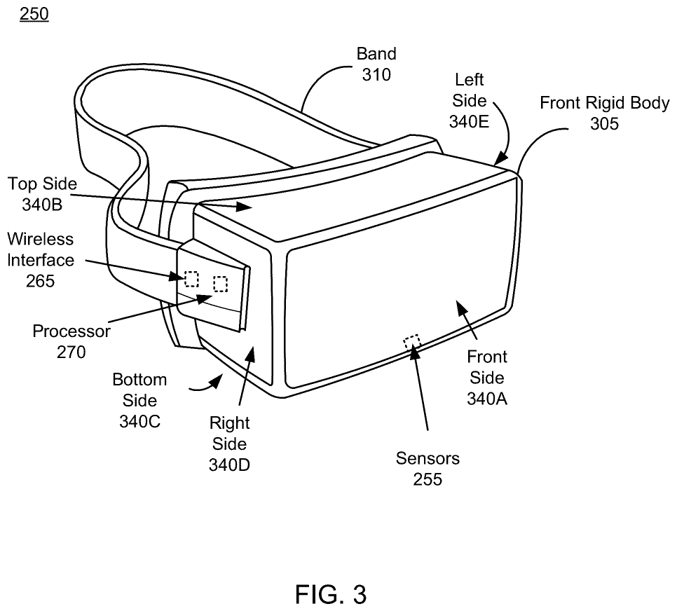

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

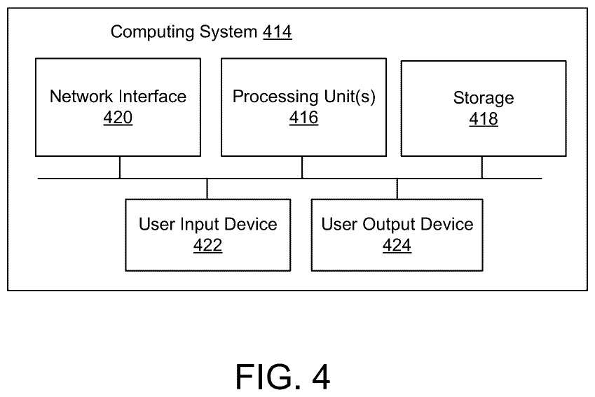

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

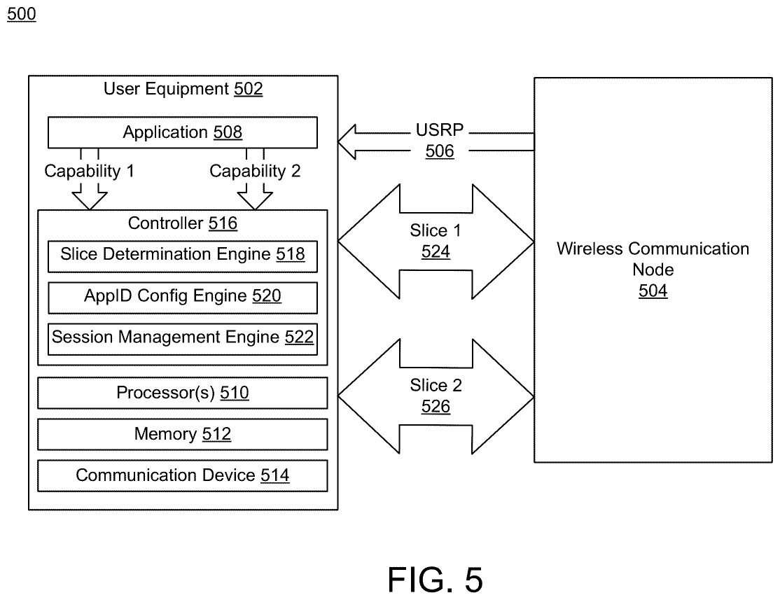

Referring generally to FIG. 5-FIG. 7, this disclosure relates to systems and methods for dynamic slice selection based on application data session services. Currently, an application identifies an application identifier (AppID) in requesting for a connection slice for a cellular session establishment. However, each application may have different services and corresponding QoS characteristics (e.g., round trip time, reliability, burst size, burst interval, or bandwidth) for its data transactions. An application may not be able to properly or fairly determine and request for a suitable slice connection to satisfy its traffic requirements. A predefined AppID may bring up a single corresponding PDU session (e.g., assigned/mapped to the AppID), irrespective of various data session requirements. In this regard, a corresponding PDU session may not maximize network performance and may utilize unnecessary network resources.

The present solution addresses the problems by categorizing data session characteristics and configuring multiple network slices (e.g., an enhanced mobile broadband (eMBB) slice or an ultra reliable low latency communication (URLLC) slice) that can be selected as a best choice for a data session. Each slice may have different capabilities. A framework or controller (e.g., a user equipment (UE), which may be the OS of the UE, or which may be a paired device of the UE) may determine an interface for a data network to satisfy the data session requirements. The framework can be an android framework, iOS framework, or windows framework. The framework may use a mapping table to check existing connections and at least one available UE route selection policy (URSP). The framework may select, determine, or otherwise configure an appropriate AppID to request the network for a corresponding slice connection. If the requirements can be satisfied with existing connections, the data session may be served without bringing up a new slice connection. For example, when a messenger application starts a video call, the framework may identify network capabilities and may find a best AppID for the requested service, which can be an AppID for eMBB slice protocol data unit (PDU) session. When the messenger starts an augmented reality (AR) call, the application may request low latency network capability. The controller may determine if another slice is available or can be established for the requested service. The other slice can be an URLLC slice PDU session. Once the URLLC slice PDU session is connected, the application may use the assigned link properties and another interface for the AR call. The call may transfer from the eMBB to URLLC slice connection if the call is transitioned from the video call to the AR call. This can provide better user experience by utilizing the URLLC slice network capabilities during the AR call. Additionally, the controller can determine if the default bearer of a slice is sufficient for the application, or if a dedicated bearer (which allocates additional resources) should be requested for that slice to support the application.

The systems and methods of dynamic AppID selection described herein may provide a better data quality by assigning available network resources and capabilities to applications, thereby improving overall network resource allocation and utilization, and/or reducing signaling to the network (by checking if an available slice connection and/or bearer can be used, prior to sending requests to establish such new connections).

Referring now to FIG. 5, depicted is a block diagram of a system 500 for selection of a cellular slice for application traffic, according to an example implementation of the present disclosure. The system 500 may include user equipment 502 (or wireless communication device) communicably coupled to a wireless communication node 504. The user equipment 502 may be similar to the user equipment 120, console 210, and/or head wearable display 250 described above with reference to FIG. 1-FIG. 4. In some embodiments, the user equipment 502 may include a plurality of user equipment 502 paired with one another (e.g., a first user equipment 502, such as a HWD 250, paired or otherwise communicably coupled with a second user equipment 502, such as a console 210). The wireless communication node 504 may be, include, or be similar to the base station 110 described above with reference to FIG. 1.

As described in greater detail below, the wireless communication node 504 may be configured to transmit, communicate, or otherwise provide user equipment route selection policy (USRP) rules 506 to the user equipment 502. The USRP rules 506 may indicate criteria/criterion for selecting application identifiers based on session capabilities and corresponding QoS slices. The user equipment 502 may be configured to receive a message indicating a change in session capabilities from an application 508 with a first session (e.g., corresponding to a first bearer within a first quality of service (QOS) slice) associated with a first application identifier. The user equipment 502 may be configured to establish, select, or otherwise configure a new application identifier for the application 508, based on the change in session capabilities. The user equipment 502 may be configured to transmit traffic of the application 508, using the second application identifier, via a second session.

The user equipment 502 may one or more processors 510, memory 512, and a communication device 514. While shown as included on the user equipment 502, in various embodiments, the wireless communication node 504 may similarly include processor(s), memory, and a communication device. The processor(s) 510 may be the same as or similar to the processors 114, 124, 230, 270 and/or processing unit(s) 416 described above with reference to FIG. 1-FIG. 4. The memory 512 may be the same as or similar to memory 116, 126, and/or storage 418 described above with reference to FIG. 1-FIG. 4. The communication device 514 may be the same as or similar to the wireless interface 112, 122, 215, 265 (e.g., in combination with or communicably coupled to antenna 118, 128) and/or network interface 420 described above with reference to FIG. 1-FIG. 4.

In some embodiments, such as where the system 500 includes paired user equipment 502, both the user equipment 502 and the paired user equipment 502 may include processors 510, memory 512, and communication devices 514 (similar to the console 210 and head wearable display 250 shown in FIG. 2 and described above). For example, and in various embodiments, the application 508 may be at least partially executed or otherwise supported by both the user equipment 502 and paired user equipment 502. In such an example, one user equipment 502 may be configured to at least partially execute the application 508, and generate packets/data/information/traffic which is sent to the other user equipment 502, and the other user equipment 502 may correspondingly communicate the traffic to the wireless communication node 504 for transmission to another endpoint (e.g., another user equipment or an application server).

The user equipment 502 may include a controller 516. The controller 516 may be any component, element, hardware, or framework designed or configured to manage sessions corresponding to applications 508 executing or otherwise supported by the user equipment 502. In some embodiments, the controller 516 may be an operating system (OS) controller (e.g., a controller deployed or executed at an OS of the user equipment 502). The controller 516 may include various processing engines for managing sessions. The processing engine(s) may be or include any device, component, element, or hardware designed or configured to perform one or more of the functions described herein. The processing engine(s) may include a slice determination engine 518, an AppID configuration engine 520, and a session management engine 522. While these processing engine(s) are shown and described herein, it should be understood that additional and/or alternative processing engine(s) may be implemented on the user equipment 502. Additionally, two or more of the processing engine(s) may be implemented as a single processing engine. Furthermore, one of the processing engine(s) may implemented as multiple processing engines.

The application 508 may be or include any type of application 508 which may support a variety of different services or capabilities within a session. For example, the application 508 may be a communication application, such as a messenger or video conferencing tool, configured to support services like voice calls, video calls, or augmented reality (AR) avatar-based calls. In such cases, the services or capabilities of the application 508 which are used during a session may dynamically adjust based on user interactions or requests. For instance, the application 508 may initially establish a voice call, corresponding to a service requiring moderate bandwidth and latency, and subsequently transition to a video call, which may involve higher bandwidth and enhanced quality of service. Further, the application 508 may switch to an AR avatar call, requiring ultra-low latency and highly reliable communication, thereby triggering adjustments to the session capabilities. Another example of an application 508 may include a gaming application, where capabilities or services could shift between text-based chat, in-game voice communication, or immersive AR-based interactions.

Where the application 508 involves communication of any such data/information/traffic to another endpoint (such as another user equipment 502 or an application server), the application 508 may request a session for transmission of such data. To establish a session (e.g., at application 508 launch, upon requesting initiating a call or online gaming, etc. on the application 508, and so forth), the application 508 may send a message to the controller 516. The message may include, among other information, session capability information of the application 508 which is to be used for the session. The session capability information may include the capabilities which are requested to be used during the session (e.g., by the end-user, along with any other supporting capabilities). For example, where the end-user launches the application 508 and requests a voice call, the message may include or otherwise identify session capability information which indicates the session is to be used for a voice call. Additionally, as the capabilities change during the session (e.g., the end-user switches from voice to video, voice to an AR avatar call, and so forth), the application 508 may be configured to transmit subsequent messages indicating changes in the services used by the application 508.

In some embodiments, the message(s) sent by the application 508 to the controller 516 may include additional information relating to the session, other than the session capability information. For example, the message may include or otherwise identify QoS parameters, such as latency, bandwidth, reliability, or jitter tolerances, relating to the session of the application 508. Further, the message may include traffic descriptors, such as packet size, flow characteristics, or expected traffic patterns. Additionally, the message may also include priority levels or service preferences to indicate whether the session should be prioritized over other ongoing sessions. For example, a message initiating an AR avatar call might indicate an ultra-low latency requirement and a high priority level. The message may also identify device capability information, such as supported codecs, hardware settings, or energy-saving modes. The message may further include user context data, such as location, device mobility patterns, or network connectivity status.

The controller 516 may include a slice determination engine 518. The slice determination engine 518 may be designed or configured to identify, select, or otherwise determine a quality of service (QOS) slice in which to maintain a session for an application 508. As shown in FIG. 5, the wireless communication node 504 may be configured to support various types of QoS slices 524, 526. A QoS slice 524, 526 may be or include a virtualized network partition which is configured for specific QoS characteristics. For example, the QoS slices 524, 526 may include an eMBB slice (e.g., for high-bandwidth services), a URLLC slice (e.g., for ultra-low latency and high reliability), an mMTC slice (e.g., for loT connectivity), V2X slice (e.g., for vehicular communications), and any other types of QoS slices.

The slice determination engine 518 may be configured to determine the QoS slice from a plurality of QoS slices, based on the message received from the application 508. In some embodiments, the slice determination engine 518 may be configured to determine the QoS slice, based on the session capability information from the application 508. For example, the session capability information may include latency requirements, bandwidth demands, reliability constraints, mobility characteristics, and other QoS parameters specific to the service requested by the application. The slice determination engine 518 analyzes session capability information to identify, determine, or otherwise select a QoS slice for supporting the session. For instance, if the session capability information indicates support for ultra-low latency and high reliability—as may be used for an AR avatar call—the slice determination engine 518 may select a QoS slice as the URLCC slice. Similarly, if the session capability information indicates support for services using high bandwidth but moderate latency tolerance, such as streaming video or a video call, the slice determination engine 518 may select a QoS slice as an eMBB slice.

The AppID configuration engine 520 may be designed or configured to select, determine, identify, or otherwise configure an application identifier (AppID) for the application 508, based on the determined slice and the USRP rules 506. As described above, the USRP rules 506 may include criteria, guidelines, rules, configurations, or policies for selecting a type of AppID for a particular session based on the capabilities/resources used for the session. The USRP rules 506 may indicate, identify, configure, or otherwise specify AppID types for sessions, based on factors such as the session capability information provided by the application 508, the determined QoS slice, and applicable network policies or conditions. For example, the USRP rules 506 may indicate that, for sessions which may use high bandwidth and can tolerate moderate latency, such as video streaming, an AppID type suitable for use with an eMBB slice is to be selected for such sessions. Similarly, the USRP rules 506 may indicate that, for sessions which are to support communications with ultra-low latency and high reliability, such as AR avatar calls, an AppID type suitable for use with a URLLC slice is to be selected for such sessions.

The AppID configuration engine 520 may be configured to select an AppID for the application 508, using the USRP rules 506 and the corresponding determined slice. For example, the AppID configuration engine 520 may be configured to select an AppID for the application 508 which has an AppID type that corresponds to the determined slice according to the USRP rules 506. For example, where the determined slice is a URLLC slice, the AppID configuration engine 520 may be configured to select an AppID of an AppID which is suitable for use with a URLLC slice as indicated in the USRP rules 506. Similarly, where the determined slice is an eMBB slice, the AppID configuration engine 520 may be configured to select an AppID of an AppID which is suitable for use with an eMBB slice as indicated in the USRP rules 506.

In some embodiments, the AppID configuration engine 520 may be configured to select the AppID by determining whether any currently-used AppIDs have the AppID type which corresponds to the determined QoS slice. For example, if another application has an active session with a bearer associated with the determined QoS slice, the AppID configuration engine 520 may be configured to identify the AppID already in use for that session. If the existing AppID type matches the session capability information of the application 508 and aligns with the determined QoS slice, the AppID configuration engine 520 may re-use the same AppID for the application 508. In this regard, the AppID configuration engine 520 may be configured to re-use the same AppID for the application 508, thereby avoiding the need to configure a new AppID or establish a separate bearer. Rather, the existing session and bearer (e.g., established in connection with the session of the other application) may be used by mapping the traffic from the application 508 to the existing session and bearer through reuse of the AppID corresponding to such session. For example, if the application 508 initiates a video call and the slice determination engine 518 identifies that an eMBB slice is to be used, the AppID configuration engine 520 may check if another application already has an active session with an existing bearer under the eMBB slice. If so, the AppID configuration engine 520 may reuses the AppID corresponding to that active session such that the video call traffic is routed to the corresponding bearer, without establishing a new session or bearer, thereby optimizing resource usage and reducing latency associated with new session setup. In instances in which the AppID configuration engine 520 does not identify an active session under the determined QoS slice, the AppID configuration engine 520 may be configured to generate, determine, select, or otherwise configure an AppID for the application 508 having the AppID type which corresponds to the determined QoS slice.

The session management engine 522 may be configured to control, maintain, or otherwise manage session(s) of the user equipment 502. The session management engine 522 may be configured to manage sessions by routing traffic, according to the AppIDs, for delivery to the wireless communication node 504. The session management engine 522 may be configured to communicate, transmit, send, or otherwise provide traffic of the application(s) 508, using the AppID configured by the AppID configuration engine 520, on a corresponding session to the wireless communication node 504. In some embodiments, the session management engine 522 may be configured to facilitate establishing sessions with the wireless communication node 504, and/or using existing sessions for additional applications. For example, the session management engine 522 may be configured to facilitate establishing a new session by initiating a request for a bearer under the QoS slice, where the request indicates or identifies the determined AppID. Additionally, the session management engine 522 may be configured to manage using existing sessions for additional applications by requesting an additional QoS flow with the bearer under the QoS flow for the AppID (e.g., an AppID which is currently used by a different application and is now reused and configured for the application).

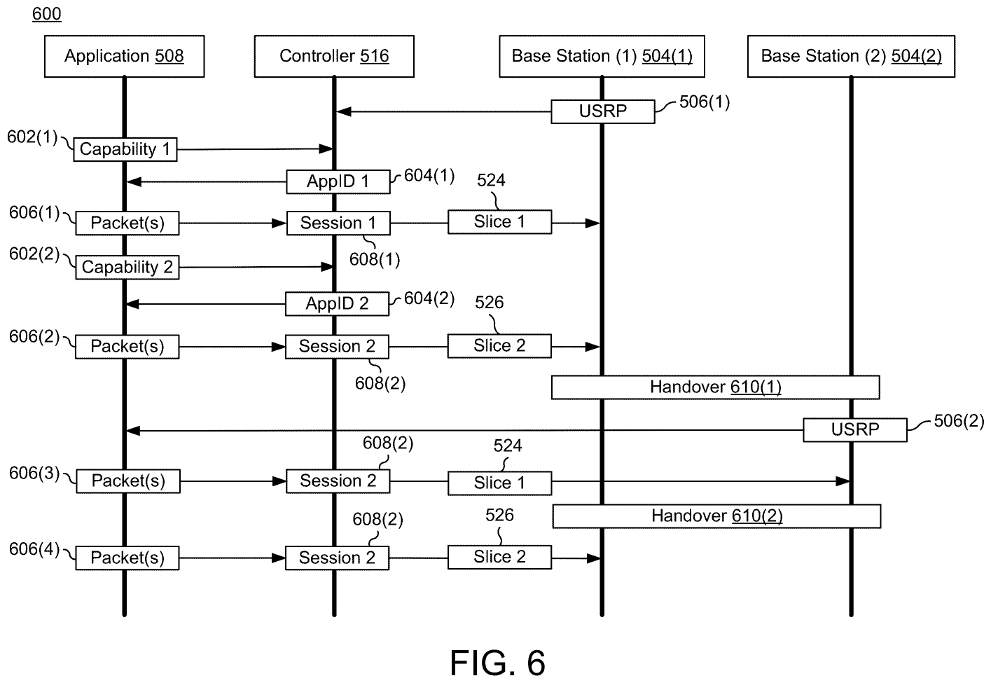

Referring now to FIG. 6, depicted is a process flow 600 showing dynamic slice selection based on application data session services, according to an example implementation of the present disclosure. As shown, the process flow 600 may be executed/implemented by the application 508, controller 516, and base stations (or wireless communication nodes) 504.

Initially, such as at initial establishment of a connection (e.g., with a base station 504), the base station 504(1) may be configured to communicate, transmit, or otherwise provide USRP rules 506(1) to the controller 516. As described above, the USRP rules 506(1) may identify criterion for selecting application identifiers (e.g., types of AppIDs) based on session capabilities and corresponding QoS slices.

The application 508 may be configured to signal, message, indicate, or otherwise identify a first set of session capability information to the controller 516. The first set of session capability information may indicate, identify, or otherwise signal certain services/resources/metrics relating to the session which are to be used by the application 508. For example, the first set of session capability information may indicate types of services which are to be used (e.g., voice, audio, video, avatar-based, etc. services which are to be used), QoS metrics relating to the session (e.g., latency, fidelity, priority, etc. information relating to traffic), and so forth. The controller 516 (e.g., the slice determination engine 518) may be configured to determine a QoS slice which is to be used for a session of the application 508, based on the capability information signaled by the application 508 to the controller 516.

The controller 516 may be configured to select, determine, or otherwise configure an application identifier (e.g., an AppID) for the application 508, based on the determined QoS slice. The controller 516 may be configured to configure the AppID based on the QoS slice determined by the slice determination engine 518 and the USRP rules 506(1) from the base station 504(1). For example, the controller 516 may be configured to configure the AppID for the application 508 having an AppID type which corresponds to the determined QoS slice determined by the slice determination engine 518 and as indicated in the USRP rules 506(1).

In some embodiments, the controller 516 may be configured to configure the AppID by selecting an AppID which is currently being used by another application 508 and corresponds to an active session under the determined QoS slice. In some embodiments, such as where there is not currently an active session under the determined QoS slice, the controller 516 may be configured to select a new AppID for the application which has an AppID type that corresponds to the determined QoS slice (as indicated by the USRP rules 506(1)). The controller 516 may be configured to communicate, transmit, signal, message, assign, or otherwise provide the AppID 604(1) (e.g., AppID 1 604(1)) to the application 508. The application 508 may be configured to generate packet(s)/PDUs/traffic 606(1) using the AppID (e.g., in a header, metadata, etc.), which the controller 516 transmits to the base station 504(1) on a first session 608(1) (e.g., under the QoS slice 524 determined by the slice determination engine 518).

In some instances, an end user of the application 508 may modify the configuration of the application 508 during the session 608(1). For example, the end user may initially launch the application 508 to initiate a voice call using the application 508. At a subsequent time period during the session 608(1), the end user may switch from a voice call to an avatar-based AR call. In such an instance, the session 608(1) under the first QoS slice 524 may be inadequate to support the QoS for an avatar-based AR call. For example, the first QoS slice 524 may be an eMBB slice, which may not have sufficient latency and fidelity for supporting an avatar-based AR call. While this example is provided, it is noted that further examples may be contemplated (such as switching from an avatar-based AR call to a voice call, from a video call to a high-resolution video streaming session, from a gaming session with standard interaction to an immersive virtual reality (VR) gaming experience, and so forth). Responsive to the end user modifying the configuration of the application 508 during the session, the application 602(2) may be configured to signal, indicate, message, or otherwise identify the change in session capabilities (e.g., from the capabilities 602(1) previously-signaled by the application 508) to the controller 516.

Responsive to a change in session capabilities being signaled by the application 508, the controller 516 may be configured to determine, identify, select, or otherwise configure another (e.g., a new/different) AppID 604(2) for the application 508. Like the previous AppID 604(1), the controller 516 may be configured to identify the second AppID 604(2) based on the change in session capabilities. For example, the controller 516 may be configured to determine a different QoS slice 526 which the application 508 should use, based on the change in session capabilities. The controller 516 may be configured to configure the second AppID 604(2) for the application 508, based on the different QoS slice 526 and the USRP rules 506(1). The controller 516 may configure the second AppID 604(2) for the application 508, by configuring a new AppID 604(2) and/or selecting the second AppID 604(2) based on it currently being used by another application 508 on a second session with a bearer within the different QoS slice 526. The controller 516 may be configured to communicate, transmit, send, signal, or otherwise provide the second AppID 604(2) to the application 508. The application 508 may use the second AppID 604(2) for generating subsequent packet(s)/frames/PDUs/traffic 606(2) of the application 508 for transmission to the base station 504(1) on a second session 608(2) within the second QoS slice 526. In instances where the AppID 604(2) is reused from another application 508, the second session 608(2) may be the same as the session maintained/used by the other application 508 (e.g., the session with the bearer within the QoS slice 526 associated with the AppID 604(2) used by the other application). In instances where the AppID 604(2) is a new AppID, the second session 608(2) may be a new session corresponding to the new AppID (e.g., a new session with a new bearer within the QoS slice 526).

In some instances, such as when the user equipment 502 moves to a new coverage area or otherwise changes cells of the first base station 504(1), a handover 610(1) may occur such that the user equipment 502 is serviced by a different cell (e.g., a different cell of the first base station 504(1) or a second base station 504(2)). While referred to generally as the second base station 504(2), it is noted that similar processes may be implemented in instance where the user equipment 502 changes to a different cell of the first base station 504(1). Where a handover occurs (e.g., to a different cell/different base station), the second base station 504(2) may communicate, send, or otherwise provide new USRP rules 506(2) to the controller 516. In some instances, the USRP rules 506(2) may be the same as those previously provided by the first base station 504(1) (e.g., the USRP rules 506(2) may be the same as USRP rules 506(1)). In some instances, the USRP rules 506(2) may be different. For example, the USRP rules 506(2) for the second base station 504(2) may be configure, specify, indicate, provide policies that AppID types which would have previously been associated with the second slice 526 (e.g., URLLC) under the first USRP rules 506(1) are to be associated with the first slice 524 (eMBB). Such an example may occur in scenarios where the second base station 504(2) does not support the second slice 526, or where network policy dictates a consolidation of traffic types for efficiency.

In this example, even with the new USRP rules 506(2) from the second base station 506(2), the controller 516 may be configured to maintain the same AppID 604(2) used by the application 508 (e.g., according to the changed session capability information 602(2)). In this regard, the application 508 may be configured to generate subsequent packets 606 (3) using the second AppID 604(2), which are sent on the second session 608(2). However, in this example, because the USRP rules 506(2) indicate that the second AppID 604(2) is to be associated with the first slice 524 (e.g., instead of the second slice 526), the second session 608(2) may be with a bearer within the first slice 524. In an instance where the user equipment 502 moves back into the service area of the first base station 504(1) such that another handover 610(2) occurs (or, alternatively, if the second base station 504(2) sends updated USRP rules 506(2) which now associates the second AppID 604(2) with the second slice 526, or if the user equipment 502 moves into a service area of a different base station which has similar USRP rules as those of the first base station 504(1)), because the application 508 is assigned/configured an AppID which has a type associated with the second slice 526, any subsequent packets/PDUs/traffic 606(4) sent on the second session 608(2) may be with a bearer that corresponds to the second slice 526.

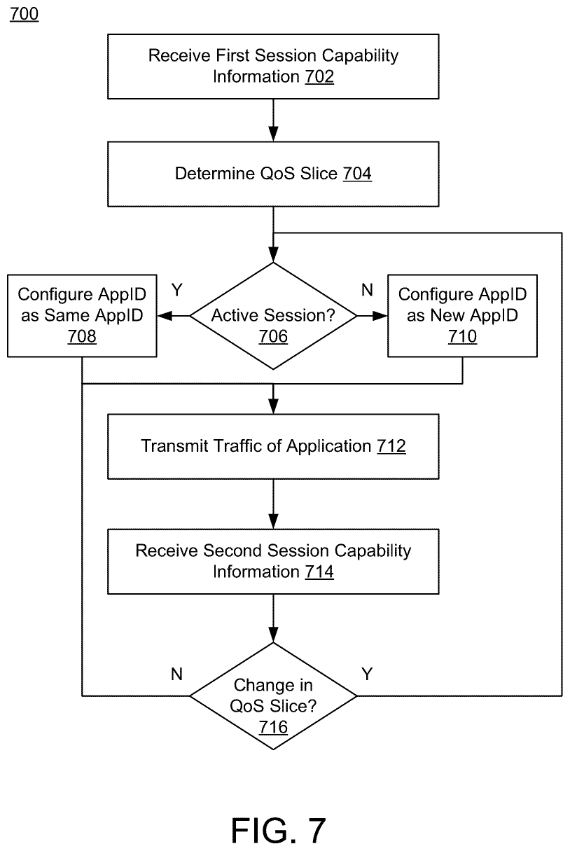

Referring now to FIG. 7, depicted is a flowchart showing an example method 700 of dynamic slice selection based on application data session services, according to an example implementation of the present disclosure. The method 700 may be performed, implemented, or executed by the hardware, devices, components, or elements described above with reference to FIG. 1-FIG. 6. For example, the method 700 may be executed by the user equipment 502 (e.g., the controller 516 of the user equipment 502) described above. As a brief overview, at step 702, a user equipment may receive first session capability information. At step 704, the user equipment may determine a QoS slice. At step 706, the user equipment may determine whether the user equipment has an active session within the QoS slice. At steps 708 and 710, the user equipment may configure an AppID based on the determination at step 706. At step 712, the user equipment may transmit traffic of the application. At step 714, the user equipment may receive second session capability information. At step 716, the user equipment may determine whether the second session capability information indicates a change in the determined QoS slice.

In some embodiments, prior to step 702, the first user equipment may receive a configuration of USRP rules from a base station. For example, the first user equipment may receive the configuration in connection with establishing a radio resource control (RRC) connection with the base station. The USRP rules may indicate one or more criterion for selecting application identifiers based on session capabilities and corresponding QoS slices. For example, the USRP rules may indicate types of application identifiers which are to use a corresponding QoS slice (e.g., a URLLC QOS slice, an eMBB QOS slice, or any other QoS slice).

At step 702, a user equipment may receive first session capability information. In some embodiments, the user equipment may receive first session capability information which indicates, identifies, or otherwise corresponds to one or more first services to be used in a first session of an application with the base station. The user equipment may receive the first session capability information in response to an end-user launching the application on the user equipment (or on another user equipment paired with the user equipment, such as on a paired device). The user equipment may receive the first session capability information responsive to the application generating a message to trigger establishing a session with the base station. For example, where the end-user launches the application and requests one or more services for use in a session of the application (e.g., a video call service, an avatar-based AR call, a video streaming service, etc.), the application may transmit the message indicating the first session capability information.

At step 704, the user equipment may determine a QoS slice. In some embodiments, the user equipment may determine the QoS slice, based on or according to the first session capability information received at step 702. For example, the user equipment may determine the QoS slice based on the USRP rules from the base station and the first session capability information. In some embodiments, the user equipment may determine which QoS slice from a plurality of QoS slices, by applying the first session capability information to a selection criterion corresponding to the QoS slices. For instance, the user equipment may maintain selection criterion for assigning specific session capabilities to QoS slices (e.g., latency sensitive session capabilities to a URLLC QOS slice, assigning high bandwidth and with moderate latency tolerance to eMBB QoS slice, etc.). The user equipment may apply the first session capability information to the selection criterion, to select or otherwise determine the QoS slice.

At step 706, the user equipment may determine whether the user equipment has an active session within the QoS slice. In some embodiments, the user equipment may identify any active sessions of other application(s) of the user equipment corresponding to a bearer within the QoS slice determined at step 704. For example, where the user equipment is executing or otherwise supporting communication for multiple applications and the user equipment determines an eMBB QoS slice based on the session capability information, the user equipment may determine whether any of the applications have a session corresponding to a bearer within the determined QoS slice (e.g., within the eMBB QoS slice).

At steps 708 and 710, the user equipment may configure an AppID based on the determination at step 706. In particular, where at step 706, the user equipment determines that an application or resource of the user equipment has an active session corresponding to a bearer within the determined QoS slice, at step 708, the user equipment may configure an AppID for the application as the AppID of the application or resource with the active session. In this regard, the application may use the same AppID as the application which has the active session. In some embodiments, the user equipment may use the active session for exchange of traffic between the user equipment (e.g., the application) and base station. In some embodiments, the user equipment may request another (e.g., a second) QoS flow within the QoS slice. For example, the user equipment may have one application with an active session that includes a first QoS flow, and the user equipment may request another QoS flow within the QoS slice for the application which sent the first session capability information at step 702. Where, at step 706, the user equipment determines that there is not an active session corresponding to a bearer within the determined QoS slice (e.g., because there are no other active sessions and/or there are active sessions in other determined QoS slices), at step 710, the user equipment may configure a new AppID for the application. In such implementations, the user equipment may request and establish a new session using the new AppID (e.g., a new session corresponding to a bearer within the QoS slice).

Following configuration of the AppID (e.g., at steps 708/710), at step 712, the user equipment may transmit traffic of the application. In some embodiments, the user equipment may transmit traffic of the application to the base station using the application identifier. The user equipment may transmit the traffic via a session (e.g., the new session or an existing session) to a bearer within the first QoS slice. The user equipment may transmit the traffic based on the AppID of the application, to the bearer within the first QoS slice.

At step 714, the user equipment may receive second session capability information. In some embodiments, the user equipment may receive the second session capability information at a subsequent time instance. For example, the user equipment may receive the second session capability information from the application, responsive to an end-user modifying a configuration of the application (e.g., modifying the configuration to change the services used in the application, from those indicated at step 702). As one example, the end-user may switch from using one or more first services in the session (such as voice or video calling services) to one or more second services (such as an avatar-based AR calling service). The application may transmit the message responsive to the end-user switching to the second service(s).

At step 716, the user equipment may determine whether the second session capability information indicates a change in the determined QoS slice. For example, the user equipment may determine whether the second session capability information received at step 714 relates to a different QoS slice (e.g., than what was previously-determined at step 704). In some embodiments, step 716 may be similar to step 704 described above (e.g., by applying selection criterion to the session capability information received at step 714). Where, at step 716, the user equipment determines that the second session capability information does not relate to a different QoS slice, the user equipment may maintain the AppID configured at steps 708/710. However, where the user equipment determines, at step 716, that the change in session capability information relates to a different QoS slice, the method 700 may loop back to step 706.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by user equipment, a message indicating a change in session capabilities, from a first session capability indicating one or more first services used in a first session to a second session capability indicating one or more second services to be used in a second session, the first session corresponding to a first bearer within a first quality of service (QOS) slice and associated with a first application identifier of an application;
configuring, by the user equipment, a second application identifier for the application based on the second session capability; and
transmitting, by the user equipment to a base station, traffic of the application, using the second application identifier, via the second session.

2. The method of claim 1, wherein the application comprises a first application, the method further comprising:
identifying, by the user equipment, based on the second session capability, an active session used by a second application within a second QoS slice; and
configuring, by the user equipment, the second application identifier responsive to identifying the active session.

3. The method of claim 2, wherein the active session includes a first QoS flow within the second QoS slice, the method further comprising:
requesting, by the user equipment, a second QoS flow within the second QoS slice for the first application.

4. The method of claim 1, further comprising:
establishing, by the user equipment, the second session for the application with the base station, the second session corresponding to a second bearer for a second QoS slice.

5. The method of claim 1, further comprising:
receiving, by the user equipment from the base station, a configuration of user equipment route selection policy (USRP) rules from the base station, the USRP rules indicating one or more criterion for selecting application identifiers based on session capabilities and corresponding QoS slices.

6. The method of claim 5, wherein the user equipment configures the second application identifier based on the USRP rules.

7. The method of claim 1, wherein the message comprises a second message, the method further comprising:
receiving, by the user equipment, a first message indicating the first session capability;
transmitting, by the user equipment to the base station, a request to establish the first session for the application based on the first session capability, the request including the first application identifier for the application; and
establishing, by the user equipment with the base station, the first session within the first QoS slice, for the application.

8. The method of claim 1, wherein the base station comprises a first base station, the traffic is sent to a cell of the first base station, and wherein the method further comprises:
maintaining, by the user equipment, the second application identifier for the application during a handover to a second cell of the first base station or a second base station;
receiving, by the user equipment, updated user equipment route selection policy (USRP) rules from the second cell; and
activating the second session within the second QoS slice based on the updated URSP rules.

9. The method of claim 1, wherein the user equipment comprises a first user equipment, and wherein the first user equipment receives the traffic for transmission to the base station from a second user equipment communicably coupled to the first user equipment.

10. A user equipment, comprising:
a transceiver; and
one or more processors configured to:
receive a message indicating a change in session capabilities, from a first session capability indicating one or more first services used in a first session to a second session capability indicating one or more second services to be used in a second session, the first session corresponding to a first bearer within a first quality of service (QOS) slice and associated with a first application identifier of an application;
configure a second application identifier for the application based on the second session capability; and
transmit, via the transceiver to a base station, traffic of the application, using the second application identifier, via the second session.

11. The user equipment of claim 10, wherein the application comprises a first application, wherein the one or more processors are configured to:
identify, based on the second session capability, an active session used by a second application within a second QoS slice; and
configure the second application identifier responsive to identifying the active session.

12. The user equipment of claim 11, wherein the active session includes a first QoS flow within the second QoS slice, wherein the one or more processors are configured to:
transmit, via the transceiver to the base station, a request for a second QoS flow within the second QoS slice for the first application.

13. The user equipment of claim 10, wherein the one or more processors are configured to:
establish, via the transceiver, the second session for the application with the base station, the second session corresponding to a second bearer for a second QoS slice.

14. The user equipment of claim 10, wherein the one or more processors are configured to:
receive, via the transceiver from the base station, a configuration of user equipment route selection policy (USRP) rules from the base station, the USRP rules indicating one or more criterion for selecting application identifiers based on session capabilities and corresponding QoS slices.

15. The user equipment of claim 14, wherein the one or more processors configure the second application identifier based on the USRP rules.

16. The user equipment of claim 10, wherein the message comprises a second message, wherein the one or more processors are configured to:
receive a first message indicating the first session capability;
transmit, via the transceiver to the base station, a request to establish the first session for the application based on the first session capability, the request including the first application identifier for the application; and
establish, via the transceiver with the base station, the first session within the first QoS slice, for the application.

17. The user equipment of claim 10, wherein the base station comprises a first base station, the traffic is sent to a cell of the first base station, and wherein the one or more processors are configured to:
maintain the second application identifier for the application during a handover to a second cell of the first base station or a second base station;
receive updated user equipment route selection policy (USRP) rules from the second cell; and
activate the second session within the second QoS slice based on the updated URSP rules.

18. The user equipment of claim 10, wherein the one or more processors are configured to receive, via the transceiver, the traffic for transmission to the base station from a second user equipment communicably coupled to the user equipment.

19. The user equipment of claim 18, wherein the traffic is received from the user equipment, responsive to the application at least partially executing on the second user equipment and generating the traffic.

20. A non-transitory computer readable medium storing instructions that, when executed by one or more processors, cause the one or more processors to:
receive a message indicating a change in session capabilities, from a first session capability indicating one or more first services used in a first session to a second session capability indicating one or more second services to be used in a second session, the first session corresponding to a first bearer within a first quality of service (QOS) slice and associated with a first application identifier of an application;
configure a second application identifier for the application based on the second session capability; and
transmit, via a transceiver to a base station, traffic of the application, using the second application identifier, via the second session.
